(19) United States
(12) Patent Application Publication
(10) Pub. No.: US 2015/0001895 A1
(43) Pub. Date: Jan. 1, 2015

(54) APPARATUS AND METHOD TO RETROFIT A RECESSED SHELF INTO THE FRONT END OF A VAN FOR MOUNTING A CONDENSER

(71) Applicant: David Ronsen, Encinitas, CA (US)

(72) Inventor: David Ronsen, Encinitas, CA (US)

(21) Appl. No.: 14/317,345

(22) Filed: Jun. 27, 2014

Related U.S. Application Data
(60) Provisional application No. 61/840,345, filed on Jun. 27, 2013.

(51) Int. Cl. B62D 25/06; B62D 65/14

(52) U.S. Cl. CPC B62D 25/06; B62D 65/14
USPC 296/210; 29/426.1

(57) ABSTRACT

A van includes a recessed shelf disposed above a driver's cabin of the van. The recessed shelf comprises a bottom planar surface, a back planar surface, a first lateral planar surface and a second lateral planar surface. The bottom planar surface is disposed from the transition section above the windshield to the back planar surface and extends from the first lateral planar surface of the recessed shelf to the second lateral planar surface of the recessed shelf. The back planar surface is disposed from the bottom planar surface to the transition section and extends from the first lateral planar surface to the second lateral planar surface. Both the first lateral planar surface and the second lateral planar surface are disposed from a side of the bottom planar surface and a side of the back planar surface to the contoured surface of the transition section.

### CROSS-REFERENCE TO RELATED APPLICATIONS

The present application claims priority to U.S. Provisional Patent Application No. 61/840,345, filed Jun. 27, 2013, entitled “APPARATUS FOR LOWERING HEIGHT OF A CONDENSER ON A VAN,” and the content of which is hereby incorporated by reference.

### TECHNICAL FIELD

This application relates to the condenser of a refrigerated van, and more specifically to retrofit a shelf that lowers the condenser into the profile of the van.

### BACKGROUND

Refrigerated vans, such as American refrigerated vans, are used to transport cargo that requires refrigeration (including freezing). A typical refrigerated van requires a powerful refrigeration system, which normally requires that a condenser be installed on the outside of the van.

### SUMMARY

This disclosure provides a method and system for a recessed shelf above the driver's cabin of a van style vehicle.

In certain embodiments, a van is provided. A van includes a transition section disposed above a driver's cabin of the van. The transition section comprises a contoured surface disposed from a windshield to a roof panel. The contoured surface extends from a first lateral edge of the van to a second lateral edge of the van. The van also includes a recessed shelf in the transition section. The recessed shelf comprises a bottom planar surface, a back planar surface, a first lateral planar surface and a second lateral planar surface. The bottom planar surface is located below the roof panel of the van, is disposed from the transition section above the windshield to the back planar surface and extends from the first lateral planar surface of the recessed shelf to the second lateral planar surface of the recessed shelf. The back planar surface is disposed from the bottom planar surface to the transition section and extends from the first lateral planar surface to the second lateral planar surface. Both the first lateral planar surface and the second lateral planar surface are disposed from a side of the bottom planar surface and a side of the back planar surface to the contoured surface of the transition section.

In certain embodiments, a method for converting a van is provided. The method includes removing a portion of a transition section of the van. The transition section is disposed above a driver's cabin of the van and comprises a contoured surface disposed from a windshield to a roof panel. The contoured surface extends from a first lateral edge of the van to a second lateral edge of the van. The method further includes fitting a recessed shelf insert into the removed portion of the transition section. The recessed shelf insert comprises a bottom planar surface, a back planar surface, a first lateral planar surface and a second lateral planar surface. The bottom planar surface is located below the roof panel of the van, is disposed from the transition section above the windshield to the back planar surface and extends from the first lateral planar surface of the recessed shelf insert to the second lateral planar surface of the recessed shelf insert. The back planar surface is disposed from the bottom planar surface to the transition section and extends from the first lateral planar surface to the second lateral planar surface. Both the first lateral planar surface and the second lateral planar surface are disposed from a side of the bottom planar surface and a side of the back planar surface to the contoured surface of the transition section.

In certain embodiments, a refrigerated van is provided. The refrigerated van includes a transition section disposed above a driver's cabin of the refrigerated van. The transition section comprises a contoured surface disposed from a windshield to a roof panel. The contoured surface extends from a first lateral edge of the refrigerated van to a second lateral edge of the refrigerated van. The refrigerated van also includes a recessed shelf in the transition section. The recessed shelf comprises a bottom planar surface, a back planar surface, a first lateral planar surface and a second lateral planar surface. The bottom planar surface is located below the roof panel of the refrigerated van, extends from the first lateral planar surface of the recessed shelf to the second lateral planar surface of the recessed shelf, extends from the transition section above the windshield to the back planar surface, and is substantially parallel with the roof panel of the refrigerated van. The bottom planar surface is located below the roof panel of the refrigerated van, is disposed from the transition section above the windshield to the back planar surface and extends from the first lateral planar surface of the recessed shelf to the second lateral planar surface of the recessed shelf. The back planar surface is disposed from the bottom planar surface to the transition section and extends from the first lateral planar surface to the second lateral planar surface. Both the first lateral planar surface and the second lateral planar surface are disposed from a side of the bottom planar surface and a side of the back planar surface to the contoured surface of the transition section.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a refrigerated cargo (panel) van with a peripheral device mounted on the roof according to one embodiment of the present disclosure;

FIG. 2 illustrates a refrigerated cargo (panel) van with a peripheral device mounted on a recessed shelf according to another embodiment of the present disclosure;

FIG. 3 illustrates a modified cargo van with a recessed shelf insert according to embodiments of the present disclosure;

FIG. 4 illustrates a recessed shelf insert according to embodiments of the present disclosure;

FIG. 5 illustrates the inside of a cargo van with a recessed shelf insert according to embodiments of the present disclosure; and

FIG. 6 is a high level flowchart for a process for retrofitting a recessed shelf insert into a transition section of a refrigerated cargo van according to embodiments of the present disclosure.

### DETAILED DESCRIPTION

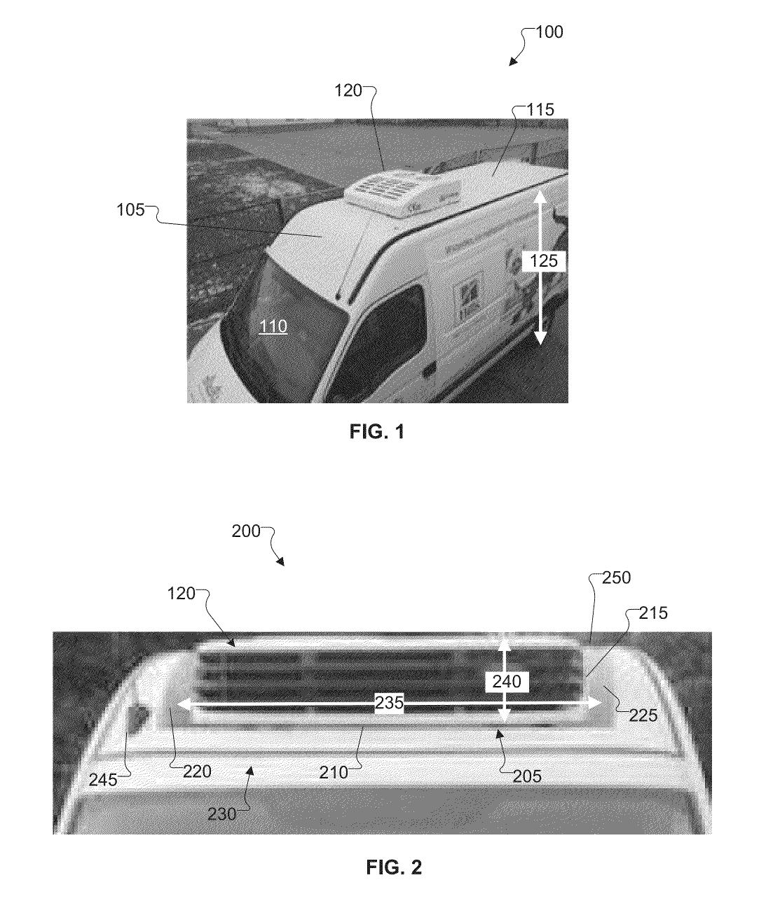

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vehicle system.

In refrigerated cargo vans, a refrigeration system is required to cool down the area inside the refrigerated compartment of a cargo van. For the refrigeration cycle to work, a condenser uses the outside air to disperse the heat extracted from the inside of the refrigeration compartment. Typically, a separate refrigeration system from the original equipment manufacturer (OEM) refrigeration system is used for cooling a refrigerated compartment. Because the condenser requires outside air in order to disperse the heat extracted, many refrigerated cargo vans install the condenser on the roof panel. Installing a condenser on the roof increases the profile of the refrigerated van, which in turn increases the drag produced while traveling. Drag is a major factor on the amount of force required to obtain and maintain a velocity, which effects the fuel consumption and efficiency of an automobile. Increasing the profile of a refrigerated car increases clearance related issues. With some refrigerated vans, such as the MERCEDES BENZ 3500 SPRINTER wide body, extending over nine feet or 108 inches over the contact point of the wheels, clearance issues are a concern. While the U.S. Department of Transportation Federal Highway Administration requires fourteen feet of clearance on most roadways, many exemptions exist for lower clearances. A number of tunnels and bridges exist below the required clearance, especially on the east coast. Along with excepted bridges and overpasses, clearance is a factor for garages and loading bays. Obstructions due to clearance issues could cause damage to the van and condenser, as well as to the object struck by the van.

FIG. 1 illustrates a cargo van 100 with a peripheral device 120 mounted on the roof panel 115 according to one embodiment of the present disclosure. The cargo van 100 of this embodiment is shown in FIG. 1 is for illustration only. Other embodiments could be used without departing from the scope of the present disclosure.

In certain embodiments, the cargo van 100 is a converted ECONOLINE style van. In other embodiments, the cargo van 100 is a European style van. The European style van refers to tall, relatively narrow vans that have been used outside of North America for many decades and that are now becoming available in the United States. The cargo van 100 is structured as a single frame structure comprising a driver's cabin and a cargo bay. The driver's cabin and cargo bay are structured as two spaces in the single enclosed area. In some embodiments, a separation wall exists between the two spaces.

In the example shown in FIG. 1, the cargo van 100 includes a transition section 105 disposed above the driver's cabin. The transition section 105 contours from the front windshield 110 to the front edge of the roof panel 115. The radius of the contour determines the amount of flat area of the transition section 105 above the windshield 110. In some embodiments, multiple radii are used in the transition section 105. The transition section 105 extends across the width of the cargo van 100. The cargo van 100 includes a peripheral device 120 installed on the roof panel 115. In this embodiment, the peripheral device 120 is a condenser of a refrigeration system.

The condenser requires air from outside the cargo van 100 to operate efficiently as part of the refrigeration system, but the efficiency of the system decreases the further away the condenser is located from the rest of the refrigeration system. While installing the condenser close to the refrigeration system on the roof panel 115 improves the efficiency of the refrigeration system, the profile height 125 of the cargo van 100 is increased as shown in FIG. 1, adding, implications concerning the drag and clearance of the cargo van 100. Increasing the drag lowers the efficiencies at which the cargo van 100 operates, including lowering the miles per gallon ratio and decreasing the control over steering and acceleration. Increasing the profile height 125 also increases the amount of clearance issues involved with some bridges, overpasses, garages, and even natural features like overhangs from trees.

FIG. 2 illustrates a cargo van 200 with a peripheral device 120 mounted on a recessed shelf 205 according to another embodiment of the present disclosure. The cargo van 200 with a peripheral device 120 mounted on a recessed shelf 205 shown in the embodiment of FIG. 2 is for illustration only. Other embodiments could be used without departing from the scope of this disclosure.

While including many of the same features as cargo van 100 in FIG. 1, the cargo van 200 also includes a recessed shelf 205 in the transition section 230. The recessed shelf 205 comprises a bottom planar surface 210, a back planar surface 215, a first lateral planar surface 220 and a second lateral planar surface 225. In certain embodiments, the recessed shelf 205 is manufactured in the OEM transition section 230. In certain embodiments, the width 235 of the recessed shelf 205 is based on the width of the peripheral device 120 or is based on the width across the front of a cargo van 200. The recessed shelf 205 is depicted in FIG. 2 as being centered in the cargo van 200, but in some embodiments, the recessed shelf 205 is offset to the left side or the right side of the cargo van 200. The seams between the edges of the bottom planar surface 210, back planar surface 215, first lateral planar surface 220, second lateral planar surface 225 and the transition section 230 are chamfered. In some embodiments, the recessed shelf 205 includes modifications for accessories, such as an opening or protrusion for an antenna 245.

In certain embodiment, the depth 240 of the recessed shelf 205 is based on the depth of the peripheral device 120. In other embodiments, the highest point of the peripheral device 120 is under the roof panel 250 or the top edge of the back planar surface 215. In other embodiments, the highest point of the peripheral device 120 is at the same height or above the roof panel 250 or the top edge of the back planar surface 215. In certain embodiments, the distance between the highest point of the peripheral device 120 is one inch below the roof panel 250. In other embodiments, the depth 240 of the recessed shelf 205 is six inches.

The bottom planar surface 210 is located below the roof panel 250 of the cargo van 200. The bottom planar surface 210 is disposed from the transition section 230 to the back planar surface 215 and extends from the first lateral planar surface 220 of the recessed shelf 205 to the second lateral planar surface 225 of the recessed shelf 205. In this embodiment, the bottom planar surface 210 is substantially parallel with the roof panel 250 of the cargo van 200. In other embodiments, the bottom planar surface 210 is disposed at a slight angle from the roof panel 250, where the front side is slightly lower than the back side of the bottom planar surface 210. In some embodiments, the bottom planar surface 210 includes a drain or drain channels to assist in removing any fluids from the recessed shelf 205.

The back planar surface 215 is disposed from the bottom planar surface 210 to the transition section 230 and extends from the first lateral planar surface 220 to the second lateral planar surface 225. In some embodiments, the back planar surface 215 is substantially perpendicular with the roof panel 250 of the cargo van 200. In other embodiments, the back planar surface 215 is configured with a slight radius or slightly angled from being perpendicular with the roof panel 250, where the lower edge of the back planar surface 215 is slightly in front of the upper edge of the back planar surface 215.

Both the first lateral planar surface 220 and the second lateral planar surface 225 are disposed from a side of the bottom planar surface 210 and a side of the back planar surface 215 to the contoured surface of the transition section 230. In certain embodiments, the lateral planar surfaces 220, 225 are substantially perpendicular to the back planar surface 215. In other embodiments, the lateral planar surfaces 220, 225 are substantially perpendicular to the roof panel 250. In other embodiments, the lateral planar surfaces 220, 225 are at an angle to the roof panel 250. In some embodiments, the top sides of the lateral planar surfaces 220, 225 are spread wider apart than the lower sides of the lateral planar surfaces 220, 225. In other embodiments, lateral planar surfaces 220, 225 are at an angle with the back planar surface 215. In some embodiments the front sides of the lateral planar surfaces 220, 225 are spread wider apart than the back sides of the lateral planar surfaces 220, 225.

The recessed shelf 205 is manufactured to support a peripheral device 120. A peripheral device 120 comprises any type of object or machine to be installed on the outside of a cargo van 200, including a condenser. In certain embodiments, the recessed shelf 205 includes a peripheral device 120 installed. While the peripheral device 120 rests on the bottom planar surface 210, the peripheral device 120 are mounted to either the bottom planar surface 210, the back planar surface 215, the lateral planar surfaces 220, 225, or a combination of the surfaces. In certain embodiments, the recessed shelf 205 includes openings for the connections required for the peripheral device 120. In certain embodiments, the openings are located on a single surface of the recessed shelf 205 or a combination of the bottom planar surface 210, the back planar surface 215, or the lateral planar surfaces 220, 225. In some embodiments, the peripheral device 120 is a condenser for a refrigerator system in the cargo van 200.

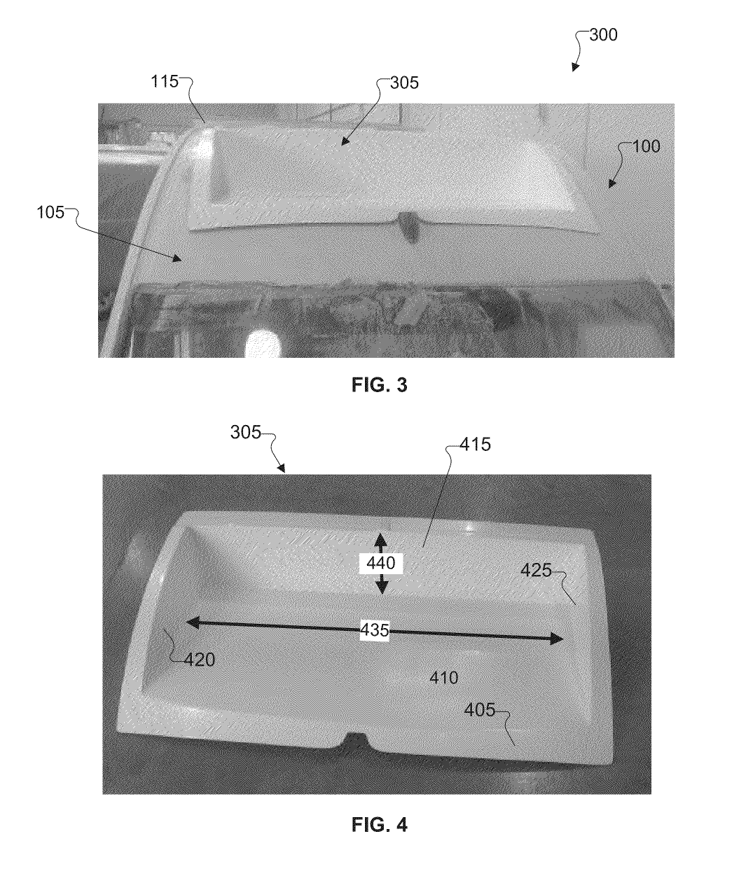

FIG. 3 illustrates a modified cargo van 300 with a recessed shelf insert 305 according to embodiments of the present disclosure. The embodiment of the modified cargo van 300 with a recessed shelf insert 305 shown in FIG. 3 is for illustration only. Other embodiments could be used without departing from the scope of the present disclosure. In certain embodiments, the modified cargo van 300 is modified, altered, or otherwise configured from the cargo van 100.

The modified cargo van 300 includes a recessed shelf insert 305 retrofitted into the transition section 105 of the cargo van 100. In this embodiment, an inner portion of the transition section 105 is removed for the recessed shelf insert 305. The inner portion which is removed keeps the recessed shelf insert 305 centered in the modified cargo van 300.

FIG. 4 illustrates a recessed shelf insert 305 according to embodiments of the present disclosure. The embodiment of the recessed shelf insert 305 shown in FIG. 3 is for illustration only. Other embodiments could be used without departing from the scope of the present disclosure.

In certain embodiments, the recessed shelf insert 305 comprises a bottom planar surface 410, a back planar surface 315, a first lateral planar surface 420, a second lateral planar surface 425 and a fringe section 405. The recessed shelf insert 305 retrofits into a transition section 105. In this embodiment, the width 435 of the recessed shelf insert 305 is based on the width of a peripheral device 120 or based on the width across the front of a cargo van 100. The seams between the edges of the bottom planar surface 410, back planar surface 415, first lateral planar surface 420, second lateral planar surface 425 and the fringe 405 are chamfered. In some embodiments, the recessed shelf insert 305 includes modifications for accessories, such as an opening or protrusion for an antenna.

In certain embodiments, the depth 440 of the recessed shelf insert 305 is based on the depth of the peripheral device 120, and the top edge of the back planar surface 415 is above the highest point of the peripheral device 120. In other embodiments, the highest point of the peripheral device 120 is at the same height or above the top edge of the back planar surface 415. In certain embodiments, the depth 440 of the peripheral device 120 is six inches.

The bottom planar surface 410 is disposed from the fringe 405 to the back planar section 415 and extends from the first lateral planar surface 420 of the recessed shelf insert 305 to the second lateral planar surface 425 of the recessed shelf insert 305. In certain embodiment, the bottom planar surface 410 is substantially parallel with the roof panel 115 of the cargo van 100. In other embodiments, the bottom planar surface 410 is disposed at a slight angle from the roof panel 115, where the front side is slightly lower than the back side of the bottom planar surface 410. In some embodiments, the bottom planar surface 410 includes a drain or drain channels to assist in removing any fluids from the recessed shelf insert 305.

The back planar surface 415 is disposed from the bottom planar surface 410 to the fringe 405 and extends from the first lateral planar surface 420 to the second lateral planar surface 425. In some embodiments, the back planar surface 415 is substantially perpendicular with the roof panel 115 of the cargo van 100. In other embodiments, the back planar surface 415 is configured with a slight radius or slightly angled from being perpendicular with the roof panel 115, where the lower edge of the back planar surface 215 is slightly in front of the upper edge of the back planar surface 215.

Both the first lateral planar surface 420 and the second lateral planar surface 425 are disposed from a side of the bottom planar surface 410 and a side of the back planar surface 415 to the contoured surface of the fringe 405. In certain embodiments, the lateral planar surfaces 420, 425 are substantially perpendicular to the back planar surface 415. In other embodiments, the lateral planar surfaces 420, 425 are substantially perpendicular to the roof panel 115. In other embodiments, the lateral planar surfaces 420, 425 are at an angle to the roof panel 115. In some embodiments, the top sides of the lateral planar surfaces 420, 425 are spread wider apart than the lower sides of the lateral planar surfaces 420, 425. In other embodiments, lateral planar surfaces 420, 425 are at an angle with the back planar surface 415. In some embodiments the front sides of the lateral planar surfaces 420, 425 are spread wider apart than the back sides of the lateral planar surfaces 420, 425.

The fringe 405 is disposed around the top edge of the back planar surface 415, the front edge of the bottom planar surface 410, and the outside edges of the planar lateral panels 420, 425. The fringe 405 extends an inch on the sides and two inches in the front and the back. In other embodiments, the fringe extends the same distance or different distances from each of the edges from which the fringe 405 is disposed. The fringe 405 aligns with the contour of the transition section 105. In certain embodiments, the fringe 405 contains portions removed for hardware found in the transition section 105, such as lights or antennas.

The recessed shelf insert 305 is manufactured to support a peripheral device 120. In certain embodiments, the recessed shelf insert 305 includes a peripheral device 120 installed. While the peripheral device 120 rests on the bottom planar surface 410, the peripheral device 120 mounts to either the bottom planar surface 410, the back planar surface 415, the lateral planar surfaces 420, 425, or a combination of the surfaces. In certain embodiments, the recessed shelf insert 305 includes openings for the connections required for the peripheral device 120. In certain embodiments, the openings are located on a single surface of the recessed shelf insert 305 or a combination of the bottom planar surface 410, the back planar surface 415, or the lateral planar surfaces 420, 425. In some embodiments, the peripheral device 120 is a condenser for a refrigerator system in the modified cargo van 300.

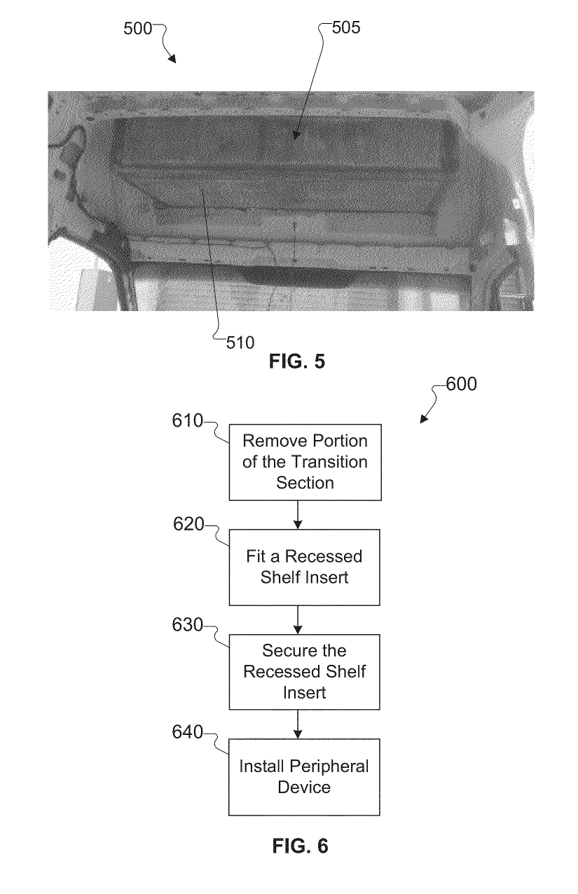

FIG. 5 illustrates the inside of a modified cargo van 500 with a recessed shelf insert 305 according to embodiments of the present disclosure. The embodiment of the inside of the modified cargo van 500 with a recessed shelf insert 305 shown in FIG. 5 is for illustration only. Other embodiments could be used without departing from the scope of the present disclosure.

In certain embodiments, a box 505 covers the recessed shelf insert 305 from the inside of the modified cargo van 500. The box 505 is configured of the same or similar material as the recessed shelf insert 305 or a completely different material, such as wood. In other embodiments, the bottom of the recessed shelf insert 305 is exposed to the cabin. In either embodiment, the bottom surface 510 of the box 505 or the bottom of the recessed shelf insert 305 are high enough to not interfere with the driver of the modified cargo van 300.

FIG. 6 illustrates a process 600 for retrofitting a recessed shelf insert 305 into a transition section 105 of a cargo van 100 according to embodiments of the present disclosure. While the flowchart depicts a series of sequential steps, unless explicitly stated, no inference should be drawn from that sequence regarding specific order of performance of steps, or portions thereof, serially rather than concurrently or in an overlapping manner, or performance the steps depicted exclusively without the occurrence of intervening or intermediate steps. The process 600 depicted in the example is implemented with a cargo van 100.

In block 610, a portion of a transition section of the van is removed. An inner portion of the transition section 105 is removed for the recessed shelf insert 305. The inner portion is removed to keep the recessed shelf insert 305 centered in the modified cargo van 300. In some embodiments, four cuts are made in the transition section 105 for the purpose of receiving the recessed shelf insert 305.

In block 620, a recessed shelf insert 305 is fit into the removed portion of the transition section 105 of the modified cargo van 300. The recessed shelf insert 305 is manufacture to support a peripheral device 120. In some embodiments, sections of the fringe 405 are removed for hardware on the modified cargo van 300.

In block 630, the recessed shelf insert 305 is secured to the transition section 105 of the modified cargo van 300. The recessed shelf insert 305 is secured by any method include welding, press fitting, or any other suitable method of securing.

In block 640, the peripheral device 120 is installed to the recessed shelf insert 305. While the peripheral device 120 rests on the bottom planar surface 410, the peripheral device 120 mounts to either the bottom planar surface 410, the back planar surface 415, the lateral planar surfaces 420, 425, or a combination of the surfaces. Installing the peripheral device 120 includes making openings in the recessed shelf insert 305 for components required to operate the peripheral device 120. In certain embodiments, the openings are located on a single panel or a combination of the bottom planar surface 410, the back planar surface 415, or the lateral planar surfaces 420, 425. In some embodiments, the peripheral device 120 is a condenser for a refrigerator system in the modified cargo van 300.

Although various features have been shown in the figures and described above, various changes includes be made to the figures. For example, the size, shape, arrangement, and layout of components shown in FIGS. 1 through 5 are for illustration only. Each component could have any suitable size, shape, and dimensions, and multiple components could have any suitable arrangement and layout. Also, various components in FIGS. 1 through 5 could be combined, further subdivided, or omitted and additional components could be added according to particular needs. Further, each component in a device or system could be implemented using any suitable structure(s) for performing the described function(s). In addition, while FIG. 6 illustrates various series of steps, various steps in FIG. 6 could overlap, occur in parallel, occur multiple times, or occur in a different order. The embodiments described herein are provided for illustration and explanation. One or more features from any of the described embodiments can be incorporated into other embodiments without departing from the scope of the disclosure.

What is claimed is:

1. A van, comprising:
a transition section disposed above a driver's cabin of the van, wherein the transition section comprises a contoured surface disposed from a windshield to a roof panel, wherein the contoured surface extends from a first lateral edge of the van to a second lateral edge of the van; and
a recessed shelf in the transition section comprising a bottom planar surface, a back planar surface, a first lateral planar surface and a second lateral planar surface;
wherein the bottom planar surface is located below the roof panel of the van, is disposed from the transition section above the windshield to the back planar surface and extends from the first lateral planar surface of the recessed shelf to the second lateral planar surface of the recessed shelf;
wherein the back planar surface is disposed from the bottom planar surface to the transition section and extends from the first lateral planar surface to the second lateral planar surface; and
wherein both the first lateral planar surface and the second lateral planar surface are disposed from a side of the bottom planar surface and a side of the back planar surface to the contoured surface of the transition section.

2. The van of claim 1, wherein a back edge of the bottom planar surface is higher than a front edge of the bottom planar surface.

3. The van of claim 1, wherein the recessed shelf is manufactured to support a peripheral device.

4. The van of claim 3, wherein the recessed shelf includes one or more openings for connections to the peripheral device.

5. The van of claim 3, wherein the width of the recessed shelf is determined based on a widest portion of the peripheral device.

6. The van of claim 3, wherein the recessed shelf is deep enough for a highest point on the peripheral device to be under the roof panel.

7. The van of claim 1, wherein a drain is installed in the recessed shelf.

8. A method for converting a van, the method comprising:
removing a portion of a transition section of the van, wherein the transition section is disposed above a driver's cabin of the van and comprises a contoured surface disposed from a windshield to a roof panel, wherein the contoured surface extends from a first lateral edge of the van to a second lateral edge of the van; and
fitting a recessed shelf insert into the removed portion of the transition section, wherein the recessed shelf insert comprises a bottom planar surface, a back planar surface, a first lateral planar surface and a second lateral planar surface;
wherein the bottom planar surface is located below the roof panel of the van, is disposed from the transition section above the windshield to the back planar surface and extends from the first lateral planar surface of the recessed shelf insert to the second lateral planar surface of the recessed shelf insert;
wherein the back planar surface is disposed from the bottom planar surface to the transition section and extends from the first lateral planar surface to the second lateral planar surface; and
wherein both the first lateral planar surface and the second lateral planar surface are disposed from a side of the bottom planar surface and a side of the back planar surface to the contoured surface of the transition section.

9. The method of claim 8, wherein the back edge of the floor is higher than the front edge of the floor.

10. The method of claim 8, wherein recessed shelf insert is manufactured to support a peripheral device.

11. The method of claim 10, wherein the recessed shelf insert includes one or more openings for connections to the peripheral device.

12. The method of claim 10, wherein the width of the recessed shelf insert is determined based on a widest portion of the peripheral device.

13. The method of claim 10, where the recessed shelf insert is deep enough for a highest point on a peripheral device to be under the roof panel.

14. The method of claim 8, wherein a drain is installed in the recessed shelf insert.

15. A refrigerated van comprising:
a transition section disposed above a driver's cabin of the refrigerated van, wherein the transition section comprises a contoured surface disposed from a windshield to a roof panel, wherein the contoured surface extends from a first lateral edge of the refrigerated van to a second lateral edge of the refrigerated van;
a recessed shelf in the transition section comprising a bottom planar surface, a back planar surface, a first lateral planar surface and a second lateral planar surface; and
a refrigeration system, wherein the refrigeration system includes a condenser mounted on the recessed shelf;
wherein the bottom planar surface is located below the roof panel of the refrigerated van, is disposed from the transition section above the windshield to the back planar surface and extends from the first lateral planar surface of the recessed shelf to the second lateral planar surface of the recessed shelf;
wherein the back planar surface is disposed from the bottom planar surface to the transition section and extends from the first lateral planar surface to the second lateral planar surface; and
wherein both the first lateral planar surface and the second lateral planar surface are disposed from a side of the bottom planar surface and a side of the back planar surface to the contoured surface of the transition section.

16. The refrigerated van of claim 15, wherein a back edge of the bottom planar surface is higher than a front edge of the bottom planar surface.

17. The refrigerated van of claim 15, wherein the recessed shelf includes one or more openings for connections to the condenser.

18. The refrigerated van of claim 15, wherein the width of the recessed shelf is determined based on a widest portion of the condenser.

19. The refrigerated van of claim 15, where the recessed shelf is deep enough for a highest point on condenser to be under the roof panel.

20. The refrigerated van of claim 15, wherein a drain is installed in the recessed shelf.
